(19) United States
(12) Patent Application Publication
(10) Pub. No.: US 2012/0159628 A1
(43) Pub. Date: Jun. 21, 2012

(54) MALWARE DETECTION APPARATUS, MALWARE DETECTION METHOD AND COMPUTER PROGRAM PRODUCT THEREOF

(75) Inventors: Shih-Yao DAI, Taipei City (TW); Yao-Tung TSOU, Yunlin County (TW); Ting-Yu LEE, Taipei City (TW); Castle YEN, Taipei City (TW); Sy-Yen KUO, Taipei City (TW); Jain-Shing WU, Taipei City (TW)

(73) Assignee: INSTITUTE FOR INFORMATION INDUSTRY, Taipei (TW)

(21) Appl. No.: 13/115,848

(22) Filed: May 25, 2011

(30) Foreign Application Priority Data
Dec. 15, 2010 (TW) 099143955

(51) Int. Cl. G06F 21/00

(52) U.S. Cl. 726/24

(57) ABSTRACT

A malware detection apparatus, a malware detection method, and a computer program product thereof are provided. The malware detection apparatus is used to detect a program. The program executes a first process. The malware detection apparatus comprises a storage unit and a processing unit. The storage unit is configured to store a malicious behavior profile of a malware. The processing unit is configured to construct a first behavior profile according to the first process, compare the first behavior profile with the malicious behavior profile and generate a comparison result. The processing unit updates a behavior record table according to the comparison result, and determines that the program is the malware according to the behavior record table.

### PRIORITY

This application claims the benefits of priority based on Taiwan Patent Application No. 099143955 filed on Dec. 15, 2010, which is hereby incorporated by reference herein in its entirety.

### FIELD

The present invention relates to a malware detection apparatus, a malware detection method and a computer program product thereof. More particularly, the present invention relates to a malware detection apparatus, a malware detection method and a computer program product thereof for detecting a program.

### BACKGROUND

With increasingly widespread application of digital information, awareness of information security protection gets gradually enhanced. This has led to development of the information security protection technologies. In information security protection solutions currently available, anti-virus software is generally used for detection of virus programs. Specifically, in order to avoid data from being stolen or disrupted, computers are generally installed with anti-virus software which has a virus database. The virus database is configured to record signatures of virus programs currently known. In this way, the anti-virus software can compare files in the computer with the signatures one by one for virus detection. If the comparison result reveals that there is a file having the same signature as a virus, then the file can be confirmed to match a virus program.

However, due to rapid development of virus programs and derivation of various mutated virus programs, updating of virus program signatures in the virus database of the antivirus software becomes inadequate to deal with the flooding malwares. More specifically, the conventional anti-virus software accomplishes detection of virus programs by comparing with a virus database. However, the signature comparison solution is limited by integrity of the virus database, and if the virus database is not updated with a signature of a mutated virus program, the anti-virus software will fail to detect the mutated virus program. Furthermore, it also takes a relatively long time to detect a virus program through signature comparison. Consequently, this degrades the efficiency of virus program detection and causes defects in information security protection. Also, updating the virus database on a continuous basis represents a high cost.

Accordingly, an urgent need exists in the art to improve the efficiency of malicious behavior comparison and accuracy of detecting virus programs.

### SUMMARY

An objective of certain embodiments of the present invention is to provide a malware detection apparatus for detecting a program. The program executes a first process. The malware detection apparatus comprises a storage unit and a processing unit. The storage unit is configured to store a malicious behavior database, wherein the malicious behavior database records a malicious behavior profile of a malware. The processing unit is electrically connected to the storage unit and configured to: construct a first behavior profile according to the first process; compare the first behavior profile with the malicious behavior profile and generate a comparison result; update a behavior record table according to the comparison result; and determine that the program is the malware according to the behavior record table.

An objective of certain embodiments of the present invention is to provide a malware detection method for the malware detection apparatus described above. The malware detection apparatus is configured to detect a program and comprises a storage unit and a processing unit. The storage unit is configured to store a malicious behavior database that records a malicious behavior profile of a malware. The processing unit is electrically connected to the storage unit. The program executes a first process. The malware detection method comprises the following steps of: (a) enabling the processing unit to construct a first behavior profile according to the first process; (b) enabling the processing unit to compare the first behavior profile with the malicious behavior profile and generate a comparison result; (c) enabling the processing unit to update a behavior record table according to the comparison result; and (d) enabling the processing unit to determine that the program is the malware according to the behavior record table.

A further objective of certain embodiments of the present invention is to provide a computer program product, storing codes of a malware detection method for a malware detection apparatus. The malware detection apparatus is configured to detect a program and comprises a storage unit and a processing unit. The storage unit is configured to store a malicious behavior database that records a malicious behavior profile of a malware. The processing unit is electrically connected to the storage unit. The program executes a first process. The computer program product comprises: a code A for enabling the processing unit to construct a first behavior profile according to the first process; a code B for enabling the processing unit to compare the first behavior profile with the malicious behavior profile and generate a comparison result; a code C for enabling the processing unit to update a behavior record table according to the comparison result; and a code D for enabling the processing unit to determine that the program is the malware according to the behavior record table.

According to the above descriptions, the malware detection apparatus of certain embodiments of the present invention stores a malicious behavior database which records a malicious behavior profile of a malware. When a program executes a first process in the malware detection apparatus of the present invention, the malware detection apparatus can construct a first behavior profile according to the first process, compare the first behavior profile with the malicious behavior profile and generate a comparison result. Then, the malware detection apparatus updates a behavior record table according to the comparison result and determines that the program is the malware according to the behavior record table. Thereby, the present invention can overcome the shortcoming of the conventional anti-virus software that updating of the virus database falls behind growth in amount of mutated malwares, and also improve the efficiency of malicious behavior comparison and the accuracy of virus program detection.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of a first embodiment of the present invention;

FIG. 2 is a schematic view illustrating a behavior profile of the present invention;

FIG. 3 is a schematic view illustrating a malicious behavior database of the present invention;

FIG. 4 is a schematic view illustrating a threshold database of the present invention;

FIG. 5 is a schematic view illustrating a behavior record table of the present invention; and

FIG. 6 is a flowchart of a second embodiment of the present invention.

### DETAILED DESCRIPTION

In the following descriptions, the present invention will be explained with reference to example embodiments thereof. However, these example embodiments are not intended to limit the present invention to any specific example, embodiment, environment, applications or particular implementations described in these example embodiments. Therefore, description of these example embodiments is only for purpose of illustration rather than to limit the present invention. It should be appreciated that, in the following example embodiments and the attached drawings, elements unrelated to the present invention are omitted from depiction; and dimensional relationships among individual elements in the attached drawings are illustrated only for ease of understanding, but not to limit the actual scale.

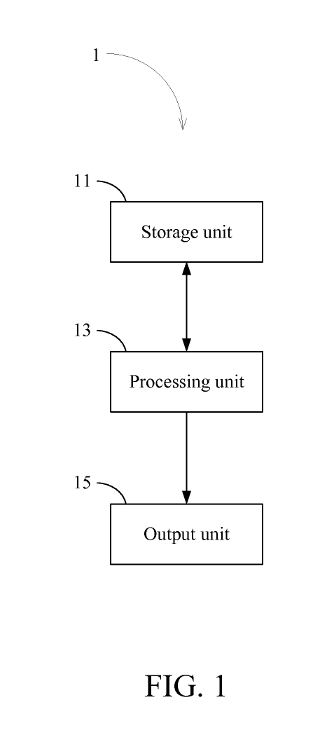

A first embodiment of the present invention is a malware detection apparatus 1, a schematic view of which is depicted in FIG. 1. The malware detection apparatus 1 comprises a storage unit 11, a processing unit 13 and an output unit 15. The storage unit 11 and the output unit 15 are electrically connected to the processing unit 13 respectively. The storage unit 11 may be a memory, a floppy disk, a hard disk, a compact disk (CD), a mobile disk, a magnetic tape, a database accessible to networks, or any other storage media with the same function and well known to those skilled in the art. The processing unit 13 may be any of various processors, central processing units (CPUs), microprocessors, calculators or other devices with a calculation capability and well-known to those skilled in the art, either currently available or to be developed in the future.

In this embodiment, the malware detection apparatus 1 is a computer; however, in other examples, the malware detection apparatus 1 may also be a server, a notebook computer, a personal digital assistant (PDA), a handset, a game machine, a digital media player or any other malware detection apparatus capable of detecting a malware. Implementation of the malware detection apparatus 1 is not intended to limit scope of the present invention.

Generally, a malware usually has one or more malicious behaviors, each of which further comprises one or more processes. In order to effectively detect a malware, specific rules must be used to depict each of the processes of the malware. For this reason, a behavior profile for depicting a process is defined in the present invention.

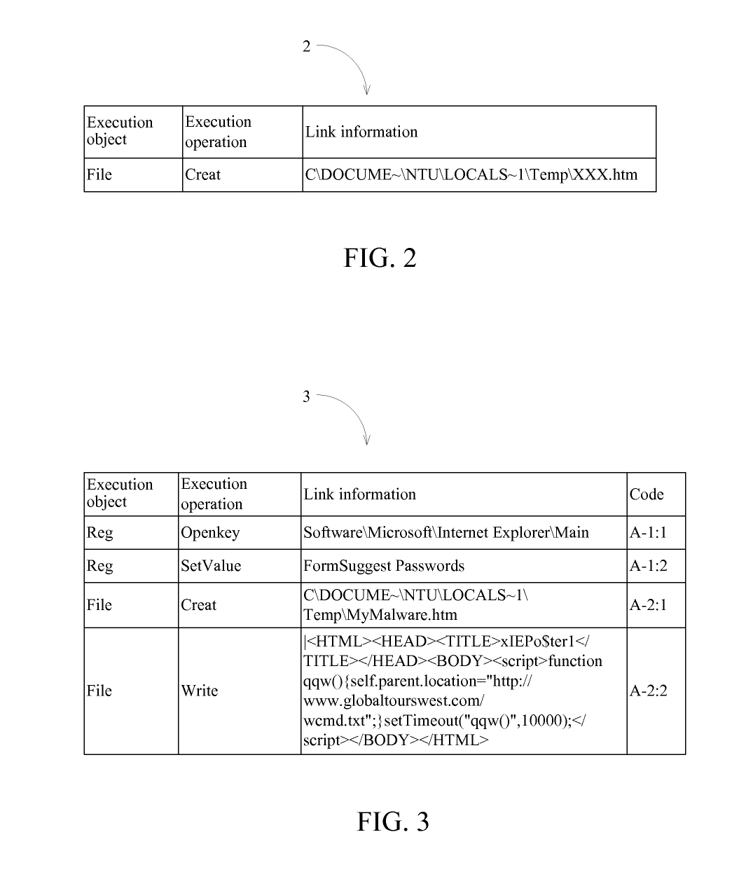

Referring to FIG. 2, a schematic view illustrating a behavior profile of the present invention is depicted therein. A behavior profile 2 defined for a process in the present invention comprises three portions, namely, an execution object, an execution operation and link information. The execution operation refers to an operation executed by the process, the execution object refers to an object of the operation executed by the process, and the link information refers to execution information involved when the process executes the operation on the object. For instance, if a process is “to create an htm file with a random name”, it means that the process is to create a file whose file name is a random name and whose secondary file name is “.htm”. In this case, the execution object of the process is “File”, the execution operation is “Create”, and the link information is a path where the htm file with a random name is created: “C\DOCUME˜\NTU\LOCALS˜1\Temp\XXX.htm”.

More specifically, a process usually performs an operation through a system call, which carries necessary information related to the process. Therefore, the execution object and the execution operation in the behavior profile 2 may be retrieved from the system call made by the process. The link information in the behavior profile 2 varies with different processes. Because different processes involves different execution information, the link information may be of any related execution information depending on practical conditions, and the forms and contents of the link information are not intended to limit scope of the present invention.

The storage unit 11 of the malware detection apparatus 1 of the present invention stores a malicious behavior database, which records various malicious behavior profiles of various malwares. How the malware detection apparatus 1 of the present invention constructs the malicious behavior database will be detailed. When a malware runs in the malware detection apparatus 1, the malware will perform one or more malicious behaviors, each of which is performed by executing one or more processes. Accordingly, when a malware executes a process in the malware detection apparatus 1, the processing unit 13 retrieves the execution object, the execution operation and the link information of the process by the way described above to generate a malicious behavior profile of the process. Meanwhile, the processing unit 13 generates a code corresponding to the malicious behavior profile according to the malicious behavior profile. The code is used to represent the malicious behavior profile so that the processing unit 13 can subsequently determine whether a program is a malware according to the code.

Now, contents of the malicious behavior database and coding of the behavior profile will be exemplified. A malware A has a malicious behavior A-1 and a malicious behavior A-2. The malicious behavior A-1 is to “modify the Internet Explorer Browser” and further execute a process A-1:1 of “opening the KEY of the Internet Explorer” and a process A-1:2 of “checking the Recommended Password field”. The malicious behavior A-2 is to “Open the Internet Explorer and try to make a connection” and further execute a process A-2:1 of “creating an htm file having a random name” and a process A-2:2 of “writing in the htm file having the random name”. The processing unit 13 retrieves the execution objects, the execution operations and the link information of the process A-1:1, the process A-1:2, the process A-2:1 and the process A-2:2 respectively to generate respective malicious behavior profiles. Then, the processing unit 13 generates a code A-1:1 representing the malicious behavior profile of the process A-1:1, a code A-1:2 representing the malicious behavior profile of the process A-1:2, a code A-2:1 representing the malicious behavior profile of the process A-2:1 and a code A-2:2 representing the malicious behavior profile of the process A-2:2.

The malicious behavior database constructed as described above is shown in FIG. 3, which is a schematic view depicting the malicious behavior database. The malicious behavior database 3 comprises malicious behavior profiles of the processes of the malware A, i.e., the execution objects, the execution operations and the link information of and the codes corresponding to the processes.

As described above, a malware has one or more malicious behaviors, each of which further comprises one or more processes. Therefore, when determining whether a program is the malware, it is necessary to determine whether the program executes the one or more processes and then determine whether processes executed by the program accumulate into the one or more malicious behaviors, so as to determine whether the malicious behaviors of the program accumulate into the malware. Accordingly, the storage unit 11 of the malware detection apparatus 1 of the present invention further stores a threshold database, which records a behavior amount threshold, a behavior profile amount threshold and types of behavior profiles that are necessary for constituting a malware.

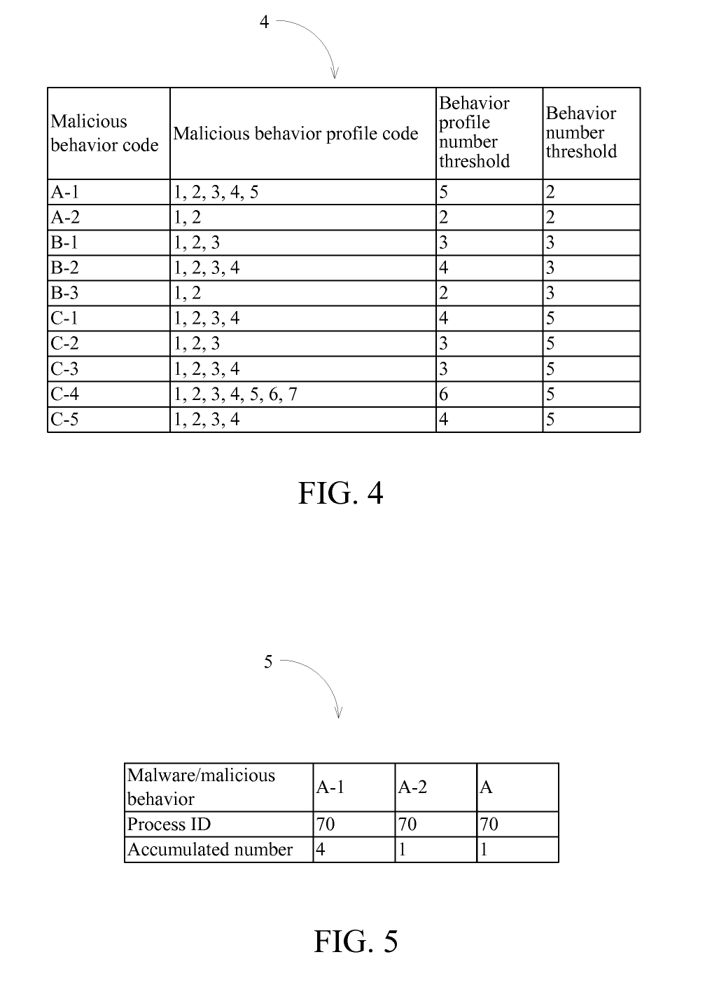

Specifically, referring to FIG. 4, a schematic view of a threshold database of the present invention is depicted therein. The “Malicious Behavior Code” field in the threshold database records types of malicious behaviors and is recorded in the aforesaid coded manner; the “Malicious Behavior Profile Code” field records types of malicious behavior profiles comprised in a malicious behavior and is recorded in a coded manner; the “Behavior Profile Amount Threshold” field records a necessary amount of malicious behavior profiles for constituting a malicious behavior; and the “Behavior Amount Threshold” field records a necessary amount of malicious behaviors for constituting a malware.

For example, a malware A has a malicious behavior A-1, so the “Malicious Behavior Code” field records “A-1”. The malicious behavior A-1 may execute five processes, so the “Malicious Behavior Profile Code” field records “1”, “2”, “3”, “4” and “5”, which are codes of five malicious behavior profiles corresponding to the five processes; i.e., “1” represents a first malicious behavior profile of the malicious behavior A-1, “2” represents a second malicious behavior profile of the malicious behavior A-1, and so on. Because the malicious behavior A-1 comprises five malicious behavior profiles, the “Behavior Profile Amount Threshold” field of the malicious behavior A-1 records “5”, which means that the malicious behavior A-1 will be constituted if five processes corresponding to the five malicious behavior profiles are executed. Because the malware A has the malicious behaviors A-1 and A-2, the “Behavior Amount Threshold” field records “2”, which means that the malware A will be constituted if the two malicious behaviors (i.e., the malicious behaviors A-1 and A-2) are performed.

Furthermore, malicious behavior profiles comprised in a malicious behavior may be classified into basic malicious behavior profiles and optional malicious behavior profiles. Specifically, a basic malicious behavior profile is one that is indispensible for constituting a malicious behavior, while an optional malicious behavior is not. Referring to the malicious behavior C-4 of FIG. 4 as an example, the “Malicious Behavior Profile Code” field thereof records “1”, “2”, “3”, “4”, “5”, “6” and “7”. Among these malicious behavior profiles, “1”, “2”, “3”, “4” and “5” are basic malicious behavior profiles, i.e., each of them is indispensable for constituting the malicious behavior C-4; and “6” and “7” are optional malicious behavior profiles, i.e., only one of the two malicious behavior profiles is necessary to constitute the malicious behavior C-4. Therefore, the behavior profile amount threshold of the malicious behavior C-4 is 6, i.e., five basic malicious behavior profiles plus one optional malicious behavior profile. The types and amounts of basic malicious behavior profiles and optional malicious behavior profiles vary depending on characteristics of malwares in practical application, but are not intended to limit scope of the present invention.

It shall be noted that, apart from being constructed by the malware detection apparatus 1 of the present invention and stored in the storage unit 11, the malicious behavior database 3 and the threshold database 4 stored in the storage unit 11 may also be constructed in advance by some other device (e.g., a computer, a server, or a computing device) and then transmitted to the malware detection apparatus 1 for storage in the storage unit 11; alternatively, they may be constructed by some other device and stored in a storage device, and then the malware detection apparatus 1 connects to the storage device to access the malicious behavior database 3 and the threshold database 4 stored therein. Therefore, the devices used to construct and store the malicious behavior database 3 and the threshold database 4 are not intended to limit scope of the present invention.

Next, how the malware detection apparatus 1 of the present invention detects a malware will be detailed. For ease of understanding, the process of detecting a malware will be described with reference to an example. Firstly, when a program runs in the malware detection apparatus 1, the program executes a first process. Then, the processing unit 13 retrieves from the first process a first execution object, a first execution operation and a first piece of link information of the first process, which are “Reg”, “Openkey” and “Software\Microsoft\Internet\Explorer\Main” respectively, and generates a first behavior profile “Reg|Openkey|Software\Microsoft\Internet\Explorer\Main”. Next, the processing unit 13 searches in the malicious behavior database 3 for a malicious behavior profile identical to the first behavior profile. As can be known from the malicious behavior database 3 of FIG. 3, the first behavior profile is identical to the malicious behavior profile whose code is A-1:1. Hence, the processing unit 13 retrieves the code A-1:1 from the malicious behavior database 3 and temporarily stores the code A-1:1 in a serial table.

On the other hand, it is possible that the malware detection apparatus 1 executes a plurality of programs simultaneously within a time period and each of the programs further comprises a plurality of processes. Because detection of a malware is accomplished through comparison of a single program to detect whether the individual program is a malware, the malware detection apparatus 1 must identify by which program a process is executed. Therefore, the processing unit 13 is further configured to append a process identification (ID) corresponding to the program to the first behavior profile. For instance, the processing unit 13 appends a code 70 to the code A-1:1 so that the first behavior profile is represented by a code A-1:1, 70, wherein the code 70 represents that the first behavior profile is executed by the program. The form of and the way to append the process ID may vary depending on practical applications, but are not intended to limit scope of the present invention.

The processing unit 13 then constructs and updates a behavior record table, for example a hash table 5, according to the aforesaid comparison results. Referring to FIG. 5, a schematic view of a behavior record table of the present invention is depicted therein. The hash table 5 is used to determine whether the amount of malicious behavior profiles that have been found through comparison by the processing unit 13 can accumulate into a malicious behavior and whether the amount of malicious behaviors can accumulate into a malware. As shown in FIG. 5, the “Malware/Malicious Behavior” field of the hash table 5 records malware codes or malicious behavior codes that has been found through comparison by the processing unit 13, the “Process ID” field records by which program a malware or malicious behavior that has been found through comparison is executed, and the “Accumulated Amount” field records the accumulated amount of malicious behavior profiles that have been found through comparison or the accumulated amount of malicious behaviors that have been found through comparison.

For instance, upon determining through comparison that the first process conforms to the malicious behavior profile whose code is A-1:1, 70, the processing unit 13 records “A-1” in the “Malware/Malicious Behavior” field of the hash table 5, records “70” in the “Process ID” field and increments the amount recorded in the “Accumulated Amount” field by 1. In this embodiment, the accumulated amount of A-1 increments from 4 to 5, which means that five malicious behavior profiles belonging to the malicious behavior A-1 have been found by the processing unit 13 through comparison. Then according to the behavior profile amount threshold (i.e., “5”) of the malicious behavior A-1 recorded in the threshold database 4, the processing unit 13 determines that the five malicious behavior profiles found through comparison have constituted the malicious behavior A-1. Therefore, the processing unit 13 further increments the accumulated amount of the malware A by 1 in the hash table 5, which means that currently one malicious behavior belonging to the malware A has been found by the processing unit 13 through comparison.

Likewise, when the program executes a second process, the processing unit 13 further determines whether the second process conforms to a malicious behavior profile through comparison in the way described above, and updates the hash table 5 according to the comparison results; and finally, the processing unit 13 may further determine whether the amount of malicious behaviors that have been found through comparison constitutes a malware according to the “Behavior Amount threshold” field in the threshold database 4. In this way, the malware detection apparatus 1 of the present invention can make a comparison on individual processes of a program one by one to determine whether the program is a malware.

Additionally, as can be known from the threshold database 4 of FIG. 4, the malicious behavior A-1 comprises the malicious behavior profiles “1”, “2”, “3”, “4” and “5”. Hence, once any of the five malicious behavior profiles is found through comparison, the processing unit 13 updates the accumulated amount of the malicious behavior A-1 in the hash table 5. However, it is possible that a program repeatedly executes a same process twice; for example, a program executes the malicious behavior profile 1 comprised in the malicious behavior A-1 twice. In this case, the accumulated amount of the malicious behavior A-1 can only be incremented by 1, otherwise a false determination would occur. Therefore, in order to avoid such a false determination, the processing unit 13 must further determine whether repeated comparisons have been made.

As described above, upon retrieving a first code from the malicious behavior database 3, the processing unit 13 temporarily stores the first code in a serial table, so this serial table can be used to check whether a code has appeared repeatedly. Then, after retrieving a second code from the malicious behavior database 3, the processing unit 13 firstly determines through comparison whether the second code has already appeared in the serial table. If the answer is “yes”, it means that a same malicious behavior profile has already been compared and the processing unit 13 will not update the hash table 5; otherwise, if the answer is “no”, it means that the code corresponds to a different malicious behavior profile and the processing unit 13 updates the hash table 5 accordingly. In this way, a false determination due to repeated comparison of a same malicious behavior profile can be avoided by the malware detection apparatus 1 of the present invention.

In the aforesaid comparison process, the processing unit 13 generates a behavior profile according to a process of a program and determines through comparison whether the behavior profile conforms to a malicious behavior profile. The comparison is made by comparing the execution object, the execution operation and the link information of the behavior profile with the malicious behavior profiles recorded in the malicious behavior database 3. However, processes of some mutated malwares may have link information that varies randomly; in other words, it might be impossible to find in the malicious behavior database 3 a malicious behavior profile that totally matches the behavior profile thus generated, thus resulting in a defect in the comparison.

To overcome this shortcoming, the malware detection apparatus 1 of the present invention further classifies the link information of processes of malwares into three kinds, namely, invariable link information, random link information, and random and continuous link information. Now, how these three kinds of link information are compared will be detailed respectively. Firstly, when link information of a process is classified as invariable link information, it means that the link information of the process is invariable, i.e., the process always generates the same link information each time is runs. Accordingly, behavior profiles generated by the processing unit 13 each time according to the process remain unchanged, so the processing unit 13 may compare the execution objects, execution operations and link information of the process with the malicious behavior database 3 directly. In other words, for the invariable link information, the comparison of a behavior profiles is made on the execution object, the execution operation and the link information simultaneously.

Secondly, when link information of a process is classified as random link information, it means that the link information of the process varies randomly; i.e., texts in content of the link information are generated randomly and the same texts appear only once and will never be used repeatedly. For instance, content of the link information includes an .exe file which has a random file name. As this .exe file has a randomly generated file name, the file name is different each time the process is executed. Briefly speaking, the process generates different link information each time it is executed. Because the behavior profile is different each time the process is executed, the processing unit 13 compares only the execution object and the execution operation of the process with the malicious behavior database 3 when a comparison is made on this kind of process. In other words, for the random link information, the comparison of a behavior profile is made only on the execution object and the execution operation.

Thirdly, when link information of a process is classified as random and continuous link information, it means that the link information of the process varies randomly and may appear continuously; i.e., texts in content of the link information are randomly generated and may be repeatedly used. For instance, a first process of a malware is to “construct an htm file having a random name”, and accordingly, the link information thereof comprises a .htm file whose file name is randomly generated, which is assumed to be “abc.htm” herein. A second process of the malware is to “write in an htm file having a random name”, and accordingly, the link information thereof also comprises “abc.htm”. Thus, although the name “abc.htm” is randomly generated, it may repeatedly appear in different processes of the malware. In view of this, when a first process of a program is classified to have random and continuous link information, the processing unit 13 temporarily stores the link information of the first process in a hash table. Then when comparing a second process of the program, the processing unit 13 determines through comparison whether the second process has link information that is identical to that temporarily stored in the hash table. If the answer is “yes”, then it means that the second process conforms to a malicious behavior profile. In the way described above, the malware detection apparatus 1 of the present invention can effectively detect various mutated malwares.

When a program is determined to be a malware through comparison, the processing unit 13 further transmits a detection result to the output unit 15. The output unit 15 is further configured to generate an image or an audio signal to notify a user that a malware is detected. The output unit 15 may be a display, a loud speaker or some other device capable of presenting a detection result, but is not merely limited thereto.

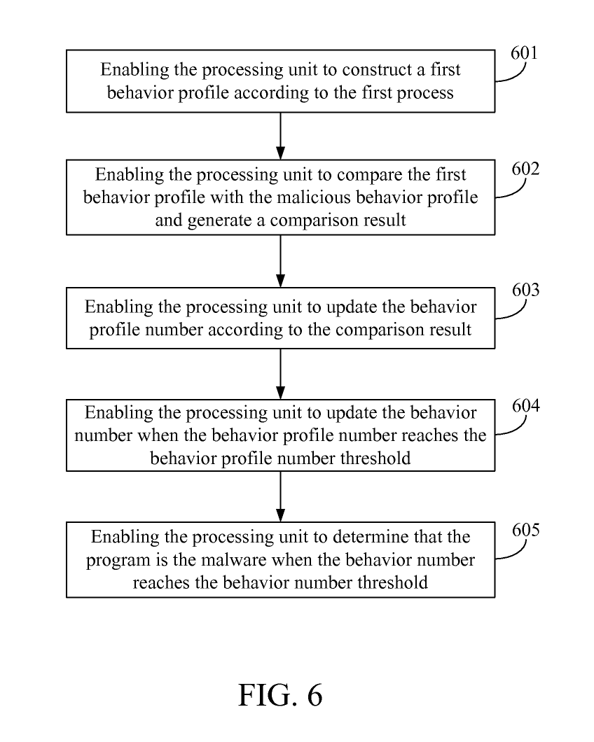

As shown in FIG. 6, a second embodiment of the present invention is a malware detection method for a malware detection apparatus as described in the first embodiment. The malware detection apparatus is configured to detect a program, and comprises a storage unit and a processing unit. The storage unit is configured to store a malicious behavior database, which records a malicious behavior profile of a malware. The processing unit is electrically connected to the storage unit. The program executes a first process.

Further, the malware detection method described in the second embodiment may be implemented by a computer program product. When the computer program product is loaded into the malware detection apparatus and a plurality of codes comprised in the computer program product is executed, the malware detection method described in the second embodiment can be accomplished. The computer program product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

FIG. 6 depicts a flowchart of a malware detection method according to the second embodiment. Firstly, the malware detection method executes step 601 to enable the processing unit to construct a first behavior profile according to the first process. Then, step 602 is executed to enable the processing unit to compare the first behavior profile with the malicious behavior profile and generate a comparison result.

The storage unit of the malware detection apparatus further stores a threshold database, which records a behavior profile amount threshold and a behavior amount threshold of the malware. The behavior record table records a behavior profile amount and a behavior amount. Next, step 603 is executed to enable the processing unit to update the behavior profile amount according to the comparison result, and step 604 is executed to enable the processing unit to update the behavior amount when the behavior profile amount reaches the behavior profile amount threshold. Finally, step 605 is executed to enable the processing unit to determine that the program is the malware when the behavior amount reaches the behavior amount threshold.

Additionally, the malware comprises a malicious behavior which executes a second process. Accordingly, prior to the step 601 of the malware detection method, step 606 (not shown in FIG. 6) may be further executed to enable the processing unit to construct the malicious behavior profile according to the second process.

Step 602 is to enable the processing unit to compare the first behavior profile with the malicious behavior profile and generate a comparison result. More specifically, the first behavior profile comprises a first execution object, a first execution operation and a first piece of link information of the first process, and the malicious behavior profile comprises a second execution object, a second execution operation and a second piece of link information of the second process. Accordingly, the step 602 of the malware detection method is to enable the processing unit to compare the first execution object with the second execution object, compare the first execution operation with the second execution operation and compare the first link information with the second link information to generate the comparison result.

In addition to the aforesaid steps, the malware detection method may further execute step 607 (not shown in FIG. 6) to enable the processing unit to append a process ID corresponding to the program to the first behavior profile so that the processing unit can determine that the first behavior profile corresponds to the program according to the process ID, and execute step 608 (not shown in FIG. 6) to enable the processing unit to generate a code corresponding to the malicious behavior profile to represent the malicious behavior profile.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

According to the above descriptions, the present invention constructs a malicious behavior database and a threshold database in advance. The malicious behavior database records a malicious behavior profile of a malware, and the threshold database records a behavior profile amount threshold and a behavior amount threshold of the malware. When a program executes a process in the malware detection apparatus of the present invention, the malware detection apparatus can construct a behavior profile according to the process, compare the behavior profile with the malicious behavior profile and generate a comparison result. Then, the malware detection apparatus updates a behavior profile amount according to the comparison result, updates a behavior amount when the behavior profile amount reaches the behavior profile amount threshold, and determines that the program is the malware when the behavior amount reaches the behavior amount threshold. Thereby, the present invention can overcome the shortcoming of the conventional anti-virus software that updating of the virus database falls behind growth in amount of mutated malwares, and also improve the efficiency of malicious behavior comparison and the accuracy of virus program detection.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A malware detection apparatus for detecting a program, the program executing a first process, the malware detection apparatus comprising:
a storage unit, being configured to store a malicious behavior database, the malicious behavior database recording a malicious behavior profile of a malware; and
a processing unit electrically connected to the storage unit, being configured to:
construct a first behavior profile according to the first process;
compare the first behavior profile with the malicious behavior profile and generate a comparison result;
update a behavior record table according to the comparison result; and
determine that the program is the malware according to the behavior record table.

2. The malware detection apparatus as claimed in claim 1, wherein the malware comprises a malicious behavior which executes a second process and the processing unit constructs the malicious behavior profile according to the second process.

3. The malware detection apparatus as claimed in claim 2, wherein the first behavior profile comprises a first execution object and a first execution operation of the first process, the malicious behavior profile comprises a second execution object and a second execution operation of the second process, and the processing unit is further configured to compare the first execution object with the second execution object and compare the first execution operation with the second execution operation to generate the comparison result.

4. The malware detection apparatus as claimed in claim 2, wherein the first behavior profile comprises a first piece of link information of the first process, the malicious behavior profile comprises a second piece of link information of the second process, and the processing unit is further configured to compare the first link information with the second link information to generate the comparison result.

5. The malware detection apparatus as claimed in claim 1, wherein the storage unit is further configured to store a threshold database, which records a behavior profile amount threshold and a behavior amount threshold of the malware, the behavior record table records a behavior profile amount and a behavior amount, and the processing unit is further configured to:
update the behavior profile amount according to the comparison result;
update the behavior amount when the behavior profile amount reaches the behavior profile amount threshold; and
determine that the program is the malware when the behavior amount reaches the behavior amount threshold.

6. The malware detection apparatus as claimed in claim 1, wherein the processing unit is further configured to append a process identification (ID) corresponding to the program to the first behavior profile so that the processing unit can determine that the first behavior profile corresponds to the program according to the process ID.

7. The malware detection apparatus as claimed in claim 1, wherein the processing unit is further configured to generate a code corresponding to the malicious behavior profile to represent the malicious behavior profile.

8. A malware detection method for a malware detection apparatus, the malware detection apparatus being configured to detect a program and comprising a storage unit and a processing unit, the storage unit being configured to store a malicious behavior database recording a malicious behavior profile of a malware, the processing unit being electrically connected to the storage unit, the program executing a first process, the malware detection method comprising the steps of:
(a) enabling the processing unit to construct a first behavior profile according to the first process;
(b) enabling the processing unit to compare the first behavior profile with the malicious behavior profile and generate a comparison result;
(c) enabling the processing unit to update a behavior record table according to the comparison result; and
(d) enabling the processing unit to determine that the program is the malware according to the behavior record table.

9. The malware detection method as claimed in claim 8, wherein the malware comprises a malicious behavior which executes a second process, the malware detection method further comprising the step of:
(e) enabling the processing unit to construct the malicious behavior profile according to the second process.

10. The malware detection method as claimed in claim 9, wherein the first behavior profile comprises a first execution object and a first execution operation of the first process, and the malicious behavior profile comprises a second execution object and a second execution operation of the second process, the malware detection method further comprising the step of:
(f) enabling the processing unit to compare the first execution object with the second execution object and compare the first execution operation with the second execution operation to generate the comparison result.

11. The malware detection method as claimed in claim 9, wherein the first behavior profile comprises a first piece of link information of the first process, and the malicious behavior profile comprises a second piece of link information of the second process, the malware detection method further comprising the step of:
(g) enabling the processing unit to compare the first link information with the second link information to generate the comparison result.

12. The malware detection method as claimed in claim 8, wherein the storage unit is further configured to store a threshold database, which records a behavior profile amount threshold and a behavior amount threshold of the malware, and the behavior record table records a behavior profile amount and a behavior amount, the malware detection method further comprising the steps of:
(h) enabling the processing unit to update the behavior profile amount according to the comparison result;
(i) enabling the processing unit to update the behavior amount when the behavior profile amount reaches the behavior profile amount threshold; and
(j) enabling the processing unit to determine that the program is the malware when the behavior amount reaches the behavior amount threshold.

13. The malware detection method as claimed in claim 8, further comprising the step of:
(k) enabling the processing unit to append a process ID corresponding to the program to the first behavior profile so that the processing unit can determine that the first behavior profile corresponds to the program according to the process ID.

14. The malware detection method as claimed in claim 8, further comprising the step of:
(l) enabling the processing unit to generate a code corresponding to the malicious behavior profile to represent the malicious behavior profile.

15. A computer program product, storing codes of a malware detection method for a malware detection apparatus, the malware detection apparatus being configured to detect a program and comprising a storage unit and a processing unit, the storage unit being configured to store a malicious behavior database recording a malicious behavior profile of a malware, the processing unit being electrically connected to the storage unit, the program executing a first process, the computer program product comprising:
a code A for enabling the processing unit to construct a first behavior profile according to the first process;
a code B for enabling the processing unit to compare the first behavior profile with the malicious behavior profile and generate a comparison result;
a code C for enabling the processing unit to update a behavior record table according to the comparison result; and
a code D for enabling the processing unit to determine that the program is the malware according to the behavior record table.

16. The computer program product as claimed in claim 15, wherein the malware comprises a malicious behavior which executes a second process, the computer program product further comprising:
a code E for enabling the processing unit to construct the malicious behavior profile according to the second process.

17. The computer program product as claimed in claim 16, wherein the first behavior profile comprises a first execution object and a first execution operation of the first process, and the malicious behavior profile comprises a second execution object and a second execution operation of the second process, the computer program product further comprising:
a code F for enabling the processing unit to compare the first execution object with the second execution object and compare the first execution operation with the second execution operation to generate the comparison result.

18. The computer program product as claimed in claim 16, wherein the first behavior profile comprises a first piece of link information of the first process, and the malicious behavior profile comprises a second piece of link information of the second process, the computer program product further comprising:
a code G for enabling the processing unit to compare the first link information with the second link information to generate the comparison result.

19. The computer program product as claimed in claim 15, wherein the storage unit is further configured to store a threshold database, which records a behavior profile amount threshold and a behavior amount threshold of the malware, and the behavior record table records a behavior profile amount and a behavior amount, the computer program product further comprising:
a code H for enabling the processing unit to update the behavior profile amount according to the comparison result;
a code I for enabling the processing unit to update the behavior amount when the behavior profile amount reaches the behavior profile amount threshold; and
a code J for enabling the processing unit to determine that the program is the malware when the behavior amount reaches the behavior amount threshold.

20. The computer program product as claimed in claim 15, further comprising:
a code K for enabling the processing unit to append a process ID corresponding to the program to the first behavior profile so that the processing unit can determine that the first behavior profile corresponds to the program according to the process ID.

21. The computer program product as claimed in claim 15, further comprising:
a code L for enabling the processing unit to generate a code corresponding to the malicious behavior profile to represent the malicious behavior profile.
